(19) United States
(12) Patent Application Publication
(10) Pub. No.: US 2026/0177698 A1
(43) Pub. Date: Jun. 25, 2026

(54) TECHNIQUES FOR RETENTION AND RECOVERY OF SINGLE-FREQUENCY DETECTION POINTS IN LIGHT DETECTION AND RANGING (LIDAR) SYSTEMS

(71) Applicant: AEVA, INC., Mountain View, CA (US)

(72) Inventors: James Nakamura, Chicago, IL (US); Kumar Bhargav Viswanatha, Santa Clara, CA (US); James Reuther, San Francisco, CA (US); Mina Rezk, Haymarket, VA (US)

(21) Appl. No.: 18/988,030

(22) Filed: Dec. 19, 2024

(51) Int. Cl. G01S 17/58; G01S 7/48; G01S 7/493; G01S 17/42

(52) U.S. Cl. CPC G01S 17/58; G01S 7/4808; G01S 7/493; G01S 17/42

(57) ABSTRACT

A light detection and ranging (LIDAR) technique that includes generating a baseband signal based on an optical beam and processing the baseband signal to identify beat frequencies corresponding with the plurality of up-chirps and down-chirps. The technique also includes identifying, in the baseband signal, a single-frequency detection comprising a detected beat frequency that lacks a complimentary beat frequency. The technique also includes computing an estimated range and an estimated velocity of a point based on the single-frequency detection and adding the point to a point cloud.

### TECHNICAL FIELD

The present disclosure relates generally to point cloud generation techniques and, more particularly, point cloud generation techniques for use in a light detection and ranging (LIDAR) system.

### BACKGROUND

Frequency-Modulated Continuous-Wave (FMCW) LIDAR systems are subject to various factors that reduce the accuracy of point detections such as noise, interference, aliasing, incorrect peak matching, and other sources of error. Such factors may lead to the false detection of a point that appears in the scene even when nothing is present. False detections may be referred to as ghost points. Various techniques exist to filter detected points to prevent ghost points from being added to the final point cloud.

### BRIEF DESCRIPTION OF THE DRAWINGS

For a more complete understanding of the various examples, reference is now made to the following detailed description taken in connection with the accompanying drawings in which like identifiers correspond to like elements.

FIG. 1A is a block diagram of an example LIDAR system according to example implementations of the present disclosure.

FIG. 1B is a block diagram illustrating a more detailed example of a signal processing unit in a LIDAR system according to embodiments of the present disclosure.

FIG. 2 is a time-frequency diagram of FMCW scanning signals that can be used by a LIDAR system according to some embodiments.

FIG. 3 is a process flow diagram of an example method for generating an estimated range and velocity (RV) measurement based on a single-frequency detection according to embodiments of the present disclosure.

FIG. 4 is a graph showing portions of an example point cloud that may be used as an external source of trusted object information according to embodiments of the present disclosure.

FIG. 5 is a line graph showing an example RV line plotted in RV space according to embodiments of the present disclosure.

FIG. 6 is a process flow diagram of an example method for generating an estimated range and velocity (RV) measurement based on a pair of single-frequency detections according to embodiments of the present disclosure.

FIG. 7 is a line graph showing an example technique for generating an estimated RV measurement using a pair of single-frequency detections according to embodiments of the present disclosure.

FIG. 8 is a process flow diagram summarizing an example method of generating a point cloud, according to an embodiment of the present disclosure.

### DETAILED DESCRIPTION

The present disclosure describes improved techniques for generating a point cloud in LIDAR systems. The described LIDAR system may be implemented in any sensing market, such as, but not limited to, transportation, manufacturing, metrology, medical, virtual reality, augmented reality, and security systems. According to some embodiments, the described LIDAR system is implemented as part of a front-end of frequency modulated continuous-wave (FMCW) device that assists with spatial awareness for automated driver assist systems, or self-driving vehicles.

LIDAR systems described by the embodiments herein include coherent scan technology to detect signals returned from targets in the environment, which are processed to add points to a point cloud. In accordance with embodiments, an optical beam with an up-chirp and a down-chirp is transmitted and a return optical beam is received from one or more objects in the field of view. The transmitted optical beam is scanned across a field of view using one or more scanning components such as rotatable mirrors and the like. The azimuth and elevation of a point are determined by the positions of the scanning components. To determine the range and velocity of a point, the returned signals are used to generate a coherent heterodyne signal, from which range and velocity information of the targets may be extracted.

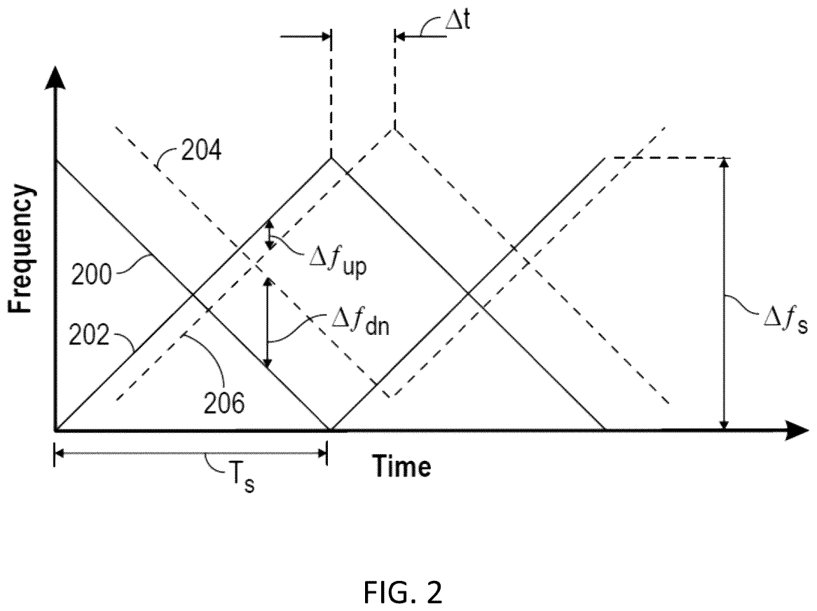

The signal associated with a point detection may include an up-sweep beat frequency (up-chirp) and a down-sweep beat frequency (down-chirp), which cause frequency peaks in the detected signal. If the frequency associated with the up-chirp (Fᵤₚ) and the frequency associated with the down-chirp (F_{dn}) are both detected, these two values can be used to determine the range and velocity of the target as described below in relation to FIG. 2.

However, in some cases, only one of these frequencies is detected, while the other frequency is either not detected at all or is rejected due to possible reliability issues. For example, false frequency peaks may appear in the signal for various reasons due to noise, negative frequency aliasing, and others. If one of the peak detections falls within a frequency range where noise is high or aliasing is more likely, such a peak detection may be disregarded to avoid adding false detections to the point cloud. If only one of the beat frequency signals (Fᵤₚ or F_{dn}) is available, this data may simply go unused with no point being added to the point cloud. This reduces the LIDAR system's probability of detection, i.e., the probability that an object will be detected.

Aspects of the present disclosure address the above-noted and other deficiencies by describing techniques that can be used to identify a valid point using a single-frequency detection method. As used herein, the term “single-frequency detection” refers to an object detection in which only one of the beat frequencies, Fᵤₚ or F_{dn}, is available, but not both. In other words, the detected beat frequency lacks the complimentary beat frequency used to compute range and velocity in accordance with conventional techniques.

According to the single-frequency detection method disclosed herein, the detected beat frequency, Fᵤₚ or F_{dn}, is used to generate a line in RV space that defines the valid possibilities for range and velocity given the detected beat frequency. This line is referred to herein as the Range-Velocity (RV) line. In some embodiments, the RV line may be characterized by a single range and a slope, which may be computed and saved for further processing. In addition to the RV line, the single-frequency detection will also be associated with a ray in the 3D environment, which is determined by the measured azimuth angle and measured elevation angle. The ray associated with the single-frequency detection may be referred to herein as the RV ray.

Given the RV line in RV space, a variety of techniques may be used to determine a point along the RV line that represents a suitable estimate for the range and velocity of a detected object. The estimated range, Rₑₛₜ, and the estimated velocity, Vₑₛₜ, provide an estimated RV measurement, which can be used (along with azimuth and elevation data) to generate a point to be added to the point cloud. In some embodiments, the estimated RV measurement may be further evaluated to ensure that the point meets some validation criteria specified for adding single-frequency detection points to the point cloud.

In some embodiments, the process for generating the estimated RV measurement starts by selecting a target point within the three-dimensional (3D) environment being scanned. The target point may be a point on or close to the RV ray that has been identified as representing a physical object according to an external source of environmental information, such as a previous frame of the point cloud or another computer vision system. The range and velocity of the target point (R_{T}, V_{T}) may be translated to the RV space and used to identify a point along the RV line that represents the estimated range and estimated velocity according to a specified selection criterion.

The techniques disclosed herein improve the probability of detection in LIDAR systems by enabling valid points to be generated for single-frequency detections using information that would normally be disregarded in conventional systems. The single-frequency detection methods disclosed herein can also be used to recover low fidelity detections that would otherwise be discarded as erroneous detections. Additionally, the single-frequency detection scheme does not require additional bandwidth and can cleanly co-exist with existing point cloud algorithms. If both frequencies are available (i.e., both frequencies peaks are detected and satisfy reliability criteria), then the range and velocity of the point is computed as usual. If only one of the frequencies is available, the single-frequency detection method disclosed herein is used to compute the range and velocity using whichever frequency is available. As used herein, an available frequency refers to a frequency peak that is detected and trusted (i.e., satisfies reliability criteria). For example, if two frequency peaks are detected but one of the frequency peaks is not trusted (e.g., falls into a known frequency spur or low return energy), the remaining frequency is available and can be converted into a single-frequency detection.

In the following description, reference may be made herein to quantitative measures, values, relationships or the like. Unless otherwise stated, any one or more if not all of these may be absolute or approximate to account for acceptable variations that may occur, such as those due to engineering tolerances or the like. These values may also be scaled or shifted depending on the Lidar parameters. Any quantitative measures are examples to demonstrate relationships rather than requirements of the invention.

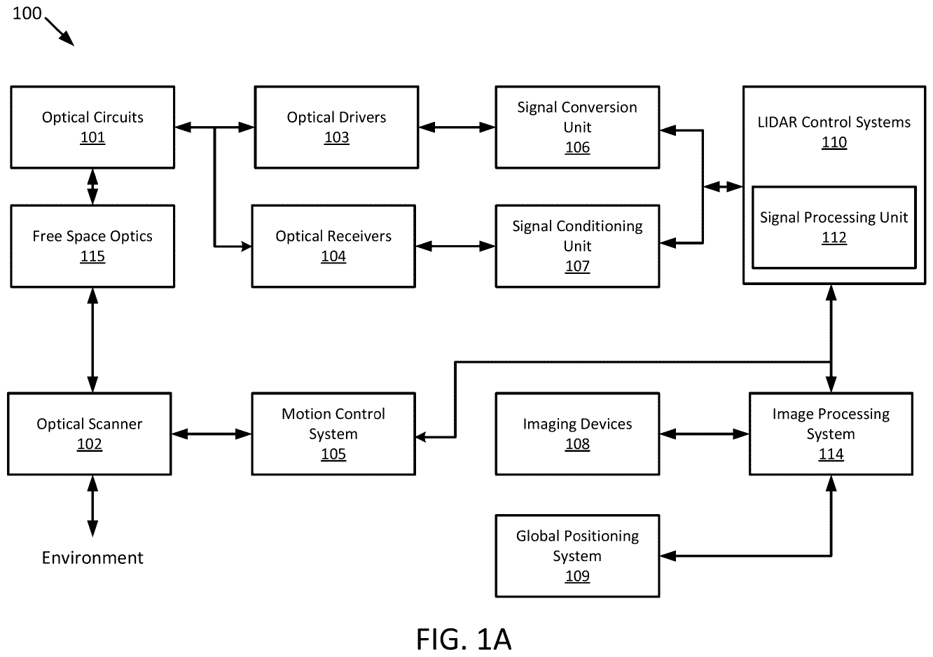

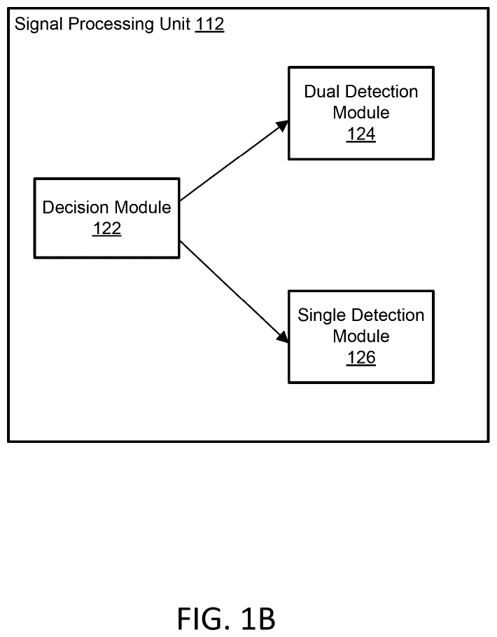

FIG. 1A is a block diagram of an example LIDAR system 100 according to example implementations of the present disclosure. The LIDAR system 100 includes one or more of each of a number of components but may include fewer or additional components than shown in FIG. 1. As shown, the LIDAR system 100 includes optical circuits 101 implemented on a photonics chip. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis (e.g., a fast-axis).

In some examples, the LIDAR system 100 includes an optical scanner 102 that includes one or more scanning mirrors that are rotatable along an axis (e.g., a slow-axis) that is orthogonal or substantially orthogonal to the fast-axis of the diffractive element to steer optical signals to scan an environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coated window or the like.

To control and support the optical circuits 101 and optical scanner 102, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control systems 110 may include a signal processing unit 112 such as a DSP. The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LIDAR control systems 110 to signals interpretable by the galvanometers in the optical scanner 102. In some examples, a motion control system 105 may also return information to the LIDAR control systems 110 about the position or operation of components of the optical scanner 102. For example, an analog-to-digital converter may in turn convert information about the galvanometers' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long-range measurements of range, velocity, azimuth, and elevation of the surrounding environment.

In some examples, the scanning process begins with the optical drivers 103 and LIDAR control systems 110. The LIDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from the environment pass through the optical circuits 101 to the receivers. Because the polarization of the light has been transformed, it may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms generates a beat frequency measured on the optical receivers (photodetectors). The combined signal can then be reflected to the optical receivers 104.

The analog signals from the optical receivers 104 are converted to digital signals using ADCs. The digital signals are then sent to the LIDAR control systems 110. A signal processing unit 112 may then receive the digital signals and interpret them. In some embodiments, the signal processing unit 112 also receives position data from the motion control system 105 and galvanometers (not shown) as well as image data from the image processing system 114. The signal processing unit 112 can then generate a 3D point cloud with information about range and velocity of points in the environment as the optical scanner 102 scans additional points. The signal processing unit 112 can also overlay a 3D point cloud data with the image data to determine velocity and distance of objects in the surrounding area. The system also processes the satellite-based navigation location data to provide a precise global location.

FIG. 1B is a block diagram 100B illustrating a more detailed example of a signal processing unit 112 in a LIDAR system according to embodiments of the present disclosure. In this example, the signal processing unit 112 includes a decision module 122, dual detection module 124, and a single-frequency detection module 126. The decision module 122 is to process the baseband signal to identify signals that can be used to compute the range and velocity of a detected object. For example, the detection module 122 can distinguish between dual frequency detections, in which both frequencies, Fᵤₚ and F_{dn}, are available, and single-frequency detections, where only Fᵤₚ or F_{dn} is available. A dual detection may be any detection in which both frequencies peaks are detected and satisfy any specified reliability criteria. Dual detections may be sent to the dual detection module 124, which computes a range and velocity as described further below in relation to FIG. 2.

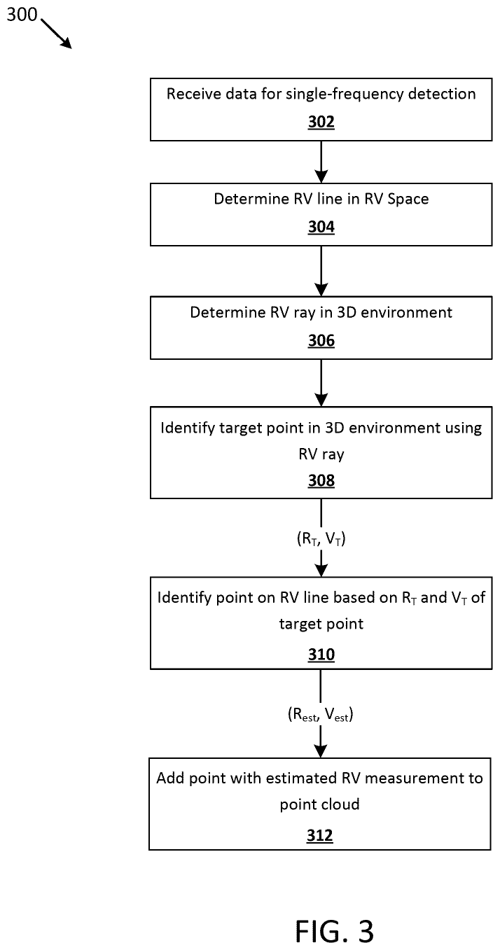

Single-frequency detections may be sent to the single-frequency detection module 126, which computes an estimated range and estimated velocity in accordance with embodiments described further below in relation to FIGS. 3-7. A single-frequency detection may be any detection in which only one frequency is detected or both frequencies are detected but one of the frequencies fail to meet specified reliability criteria. The specified reliability criteria may relate to any number of factors that affect the reliability of a detection, including the signal intensity, signal-to-noise ratio (SNR), reflectivity, and others. In some embodiments, the reliability criteria may relate to the scan region. For example, there may be more noise in certain regions that may cause the reliability of points detected in that region to be reduced.

In some embodiments, the reliability criteria may be related to negative frequency aliasing. In real sampling, all frequency peaks will be detected as having a positive frequency. Thus, if the doppler shift experienced by the down chirp causes the frequency to be negative, the peak will still be detected as positive, resulting in negative frequency aliasing. For this reason, a peak detected close to zero hertz will have an increased possibility of being a peak image (reflected across the origin), as opposed to a true peak. Thus, if the lower frequency, F_{dn}, is below a threshold value, the decision module 122 can discard (or otherwise disregard) that detected frequency to avoid a false detection. The remaining frequency, Fᵤₚ, may be sent to the single-frequency detection module 126 for computing an estimated range and velocity, which may be used to add an estimated point to the point cloud if the resulting estimate satisfies specified validity criteria, i.e., criteria for determining the validity of estimated RV measurements.

The resulting point cloud may be a combination of dual detection points and single-frequency detection points. The point cloud format may include a variety of information related to each point, including azimuth, elevation, range, and velocity. The point cloud may also include fields related to point confidence, such as intensity, SNR, and others. In some embodiments, the point cloud format may also include a field for each point indicating whether the point is a dual detection point generated by the dual detection module 124 or a single-frequency detection point generated by the single-frequency detection module 126.

FIG. 2 is a time-frequency diagram of FMCW scanning signals that can be used by a LIDAR system according to some embodiments. The FMCW scanning signals 200 and 202 may be used in any suitable LIDAR system, including the system 100, to scan a target environment. The scanning signal 200 may be a triangular waveform with an up-chirp and a down-chirp having a same bandwidth Δfₛ and period Tₛ. The other scanning signal 202 is also a triangular waveform that includes an up-chirp and a down-chirp with bandwidth Δfₛ and period Tₛ. However, the two signals are inverted versions of one another such that the up-chirp on scanning signal 200 occurs in unison with the down-chirp on scanning signal 202.

FIG. 2 also depicts example return signals 204 and 206. The return signals 204 and 206, are time-delayed versions of the scanning signals 200 and 202, where Δt is the round-trip time to and from a target illuminated by scanning signal 201. The round-trip time is given as Δt=2R/v, where R is the target range and v is the velocity of the optical beam, which is the speed of light c. The target range, R, can therefore be calculated as R=c(Δt/2).

In embodiments, the time delay Δt is not measured directly but is inferred based on the frequency differences between the outgoing scanning waveforms and the return signals. When the return signals 204 and 206 are optically mixed with the corresponding scanning signals, a signal referred to as a “beat frequency” is generated, which is caused by the combination of two waveforms of similar but slightly different frequencies. The beat frequency indicates the frequency difference between the outgoing scanning waveform and the return signal, which is linearly related to the time delay Δt by the slope of the triangular waveform.

If the return signal has been reflected from an object in motion, the frequency of the return signal will also be affected by the Doppler effect, which is shown in FIG. 2 as an upward shift of the return signals 204 and 206. Using an up-chirp and a down-chirp enables the generation of two beat frequencies, Δfᵤₚ and Δf_{dn} (also referred to herein more simply as fᵤₚ and f_{dn}). The beat frequencies Δfᵤₚ and Δf_{dn} are related to the frequency difference cause by the range, Δf_{Range}, and the frequency difference cause by the Doppler shift, Δf_{Doppler}, according to the following formulas:

$$Δ {f}_{u p} = Δ {f}_{R a n g e} - Δ {f}_{Doppler} \qquad Eq . 1$$

$$Δ {f}_{d n} = Δ {f}_{R a n g e} + Δ {f}_{Doppler} \qquad Eq . 2$$

Thus, the beat frequencies Δfᵤₚ and Δf_{dn} can be used to differentiate between frequency shifts caused by the range and frequency shifts caused by motion of the measured object. Specifically, Δf_{Doppler} is the difference between the Δfᵤₚ and Δf_{dn} and the Δf_{Range} is the average of Δfᵤₚ and Δf_{dn}.

The range to the target and velocity of the target can be computed using the following formulas:

$$Range = Δ {f}_{R a n g e} \frac{c {T}_{s}}{2 Δ {f}_{s}} \qquad Eq . 3$$

$$Velocity = Δ {f}_{Doppler} \frac{{λ}_{c}}{2} \qquad Eq . 4$$

In the above formulas, λ_{c}=c/f_{c} and f_{c} is the center frequency of the scanning signal. Equations (3) and (4) can be also be expressed as follows:

$$Range = α \cdot ( {f}_{u p} + {f}_{dn} ) Where , α = \frac{c {T}_{s}}{4 Δ {f}_{s}} \qquad Eq . 5$$

$$Velocity = β \cdot ( {f}_{u p} - {f}_{dn} ) Where , β = \frac{{λ}_{c}}{2} \qquad Eq . 6$$

The beat frequencies can be generated, for example, as an analog signal in optical receivers 104 of system 100. This analog signal, also known as a baseband signal, can then be digitized by an analog-to-digital converter (ADC), for example, in a signal conditioning unit such as signal conditioning unit 107 in LIDAR system 100. The digitized baseband signal can then be digitally processed, for example, in a signal processing unit, such as signal processing unit 112 in system 100.

In some scenarios, to ensure that the beat frequencies accurately represent the range and velocity of the object, beat frequencies can be measured at the same moment in time, as shown in FIG. 2. Otherwise, if the up-chirp beat frequency and the down-chirp beat frequencies were measured at different times, quick changes in the velocity of the object could cause inaccurate results because the Doppler effect would not be the same for both beat frequencies, meaning that equations (1) and (2) above would no longer be valid. To measure both beat frequencies at the same time, the up-chirp and down-chirp can be synchronized and transmitted simultaneously using, for example, two signals that are multiplexed together.

It will be appreciated that the modulation scheme shown in FIG. 2 is one example of a modulation scheme that can be used in accordance with embodiments. The techniques described herein may be used with any modulation scheme that enables the beat frequencies fᵤₚ and f_{dn} to be obtained so that the range and velocity can be computed according to equations (5) and (6) as described above. It will further be appreciated that the technique described in relation to FIG. 2 can be applied by the dual detection module 124 of FIG. 1B to compute the range and velocity when both beat frequencies, fᵤₚ and f_{dn}, are available. When only one beat frequency is available, the estimated range and estimated velocity may be computed by the single-frequency detection module 126 in accordance with the techniques described below.

FIG. 3 is a process flow diagram of an example method for generating an estimated range and velocity (RV) measurement based on a single-frequency detection according to embodiments of the present disclosure. The method 300 may be performed by any suitable LIDAR system, including the LIDAR system 100 described above. For example, the method 300 may be performed by the single-frequency detection module 126 as shown in FIG. 1B. The method may begin at block 302.

At block 302, data is received for a single-frequency detection. The single-frequency detection data can include spatial information such as the azimuthal angle and the elevation angle of the laser beam at the time of the detection, which is determined based on the positions of the components used to direct the laser beam. The single-frequency detection data also includes the detected beat frequency, which may be the up-sweep (up-chirp) beat frequency, fᵤₚ, or the down-sweep (down-chirp) beat frequency, f_{dn}.

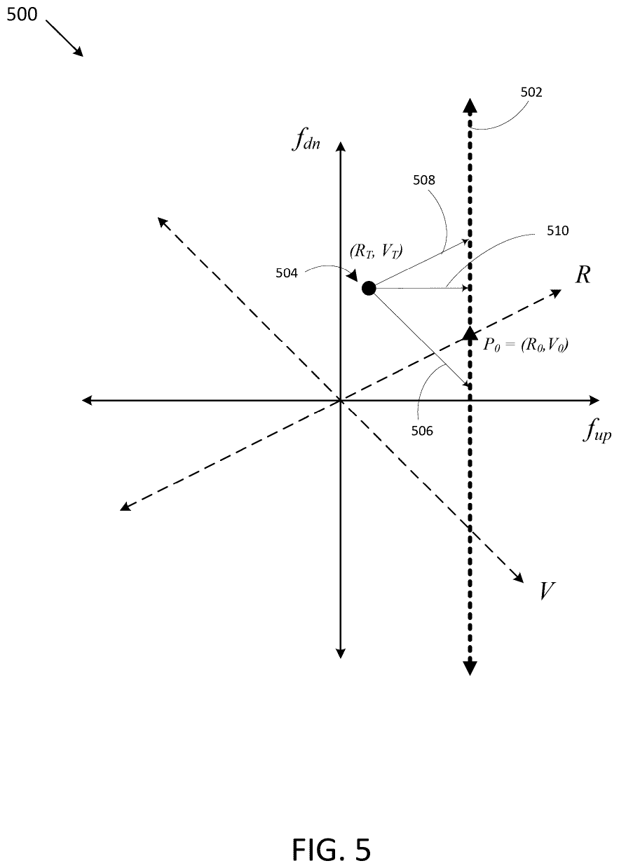

At block 304, the RV line is determined based, in part, on the detected beat frequency. The RV line is a line in RV space that describes all of the valid values for range and velocity that are consistent with the detected beat frequency. RV space describes all of the possible combinations of range and velocity and can be visualized as a line on a graph with range and velocity axes. As described further below, the RV line is a function of the detected beat frequency, the chirp rate (slope) of the laser chirp, and the laser wavelengths. In some embodiments, the chirp rate and laser wavelengths may be constant for the duration of the measurement. In such cases, the RV line will vary based on variations in the detected beat frequency. However, the chirp rate and the laser wavelengths will be used in the calculations when the point is processed. Additional details for generating the RV line are described further below in relation to FIG. 5.

At block 306, an RV ray is determined. The RV ray describes the travel direction of the optical beam in the 3D environment at a time of the single-frequency detection. The RV ray may be determined from the azimuth angle and the elevation angle of the optical beam at the time of the single-frequency detection. For example, the RV ray may be a ray originating at the origin (range=0) and extending outward in the direction of the measured azimuth and elevation angle associated with the single-frequency detection.

At block 308, a target point in the 3D environment being scanned is identified. As mentioned above, the target point may be a point on or close to the RV ray that has been identified (e.g., with a high degree of confidence) as being a part of a physical object according to an external source of environmental information describing objects in the environment. The external source of environmental information may be a previous frame of the point cloud or another computer vision system such as a camera-based system, a radar-based system, or a second LIDAR system, for example. The environmental information provided by this external source may be referred to as trusted object information. The trusted object information describes objects that have been detected in the 3D environment with a high degree of confidence. For example, if the external source is a previous frame of the point cloud, the trusted object information may include points that were detected with a high degree of reliability, e.g., points associated with a high intensity, high SNR, etc. The trusted object information may also include geometric shapes derived from the point cloud, via clustering for example. The trusted object information may describe objects in the monitored environment using any suitable type of geometric features, such as points, lines, curves, planes (e.g., ground plane), bounding boxes, etc. The trusted object information may also be velocity information derived from an external perception system or other sensor.

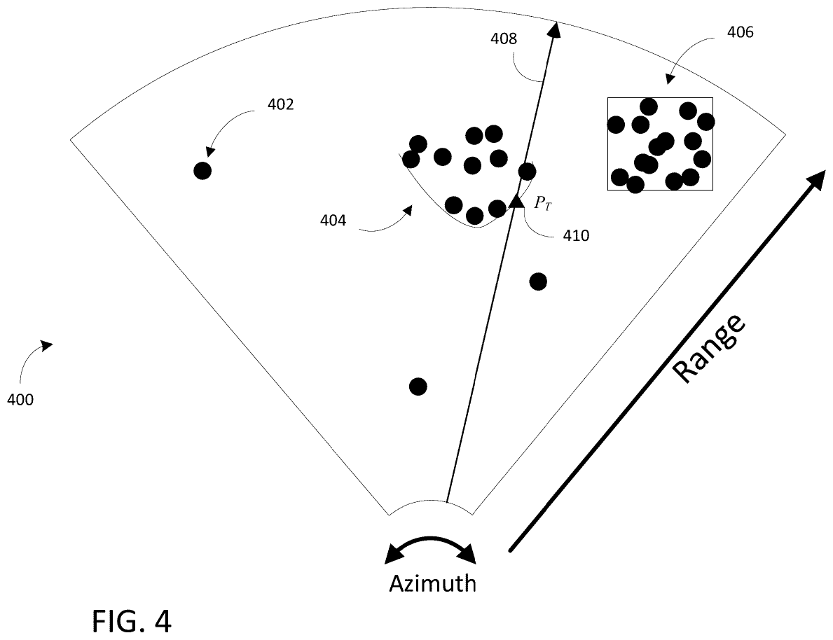

If the RV ray intersects one of the objects described in the trusted object information, the point of intersection may be selected as the target point. In cases where the RV ray does not intersect one of the objects, the point closest to the RV ray may be selected as the target point. The range of the target point may be used as the target range, R_{T}, and the velocity of the object may be used as the target velocity, V_{T}. In some embodiments, the velocity of the object may be determined as the average velocity of all of the points determined to be a part of the same object. Techniques for identifying the target point are described further below in relation to FIG. 4.

At block 310, the target range and target velocity are used to identify a point on the RV line that provides the estimated range and estimated velocity to be used for the estimated RV measurement of the single-frequency detection. The point may be selected according to one or more selection criteria, which may vary depending on the design considerations of a particular embodiment. For example, the point on the RV line with the minimum distance to the target point may be selected. In some embodiments, the point on the RV line that minimizes the weighted sum of the velocity and range difference to the target point may be selected. Various additional selection criteria may be specified, examples of which are described further in relation to FIG. 5. The selected point on the RV line describes the estimated range, Rₑₛₜ, and the estimated velocity, Vₑₛₜ, to be used for the estimated RV measurement.

At block 312, a point with the estimated RV measurement may be added to the point cloud as an estimated point. The estimated point will include the same information as other points of the point cloud including the elevation angle, azimuth angle, and range, or equivalent cartesian coordinates. The estimated point may also include an identifier, such as a Boolean flag, that identifies the point as an estimated point. In this way, the estimated points can be enabled or disabled for use in specific applications, turned off by the user, and the like.

In some embodiments, each of the estimated points may be evaluated before being added to the point cloud to determine whether it meets revival criteria specified for determining the reliability of the estimated RV measurement. For example, the revival criteria may specify a maximum allowable range difference or maximum allowable velocity difference between the target point and the selected point. If the difference between R_{T} and Rₑₛₜ is below a threshold (e.g., less than 1 meter) and/or if the difference between V_{T} and Vₑₛₜ is below a threshold (e.g., less than 0.3 meters per second) then the estimated point may be added. Otherwise, the estimated RV measurement may be disregarded and the estimated point may not be added to the point cloud. In some embodiments, the revival criteria may specify that the estimated RV measurement can be used if the weighted sum of the velocity and range difference between the target point and the selected point on the RV line is less than a threshold (e.g., less than 3). Various other criteria may be used in accordance with embodiments.

FIG. 4 is a graph showing portions of an example point cloud that may be used as an external source of trusted object information according to embodiments of the present disclosure. For ease of illustration, the graph 400 is a two-dimensional graph of the monitored 3D environment as viewed from above. However, in an actual implementation, the techniques described herein will be performed in a 3D dimensional volume. The graph 400 shown in FIG. 4 is depicted as using a spherical coordinate system (e.g., range, azimuth, and elevation). However, it will be appreciated that the present techniques can also be performed using a cartesian coordinate system (e.g., X, Y, Z).

The point cloud of FIG. 4 represents a single prior frame of the point cloud and includes multiple points 402. Each point is associated with a range, azimuth angle, and elevation angle which establish the position of the point in space. Each point may also be associated with a velocity and other potential point characteristics such as signal intensity, SNR, and others. In embodiments, the trusted object information may include object features that are identified by processing the points 402. For example, the object features can include a convex hull 404 and a bounding box 406 and may also include a ground plane (not shown). The object features may be identified through any suitable clustering algorithm such as density-based spatial clustering of applications with noise (DBSCAN), k-dimensional tree (K-D Tree) among others. The clustering algorithm is used to identify points that are closely packed, which indicates that they represent an actual object to a high degree of confidence. Each object feature may be assigned a velocity. For example, the velocity of the object feature may be the mean or median velocity of the individual points that form the cluster associated with the object feature.

The trusted object information may include trusted points, i.e., points that satisfy criteria specified to establish that the point is a true object detection. For example, points that are members of a cluster may be identified as trusted points. Additionally, points with a signal intensity and/or SNR above a threshold may be identified as trusted points.

Also shown in FIG. 4, is the RV ray 408. The RV ray 408 is a line extending from the origin and traveling in a direction associated with the single-frequency detection provided by the scanning components. Various techniques or combinations thereof may be used to identify the target point based on the point cloud and the RV ray 408. In some embodiments, the target point can be identified as a trusted point that is closest to the RV ray 408. The target range and target velocity may be set to the range and velocity of the identified target point.

In some embodiments, the target point may be identified as the intersection of the RV ray 408 and an object feature. For example, as shown in FIG. 4, the RV ray 408 intersects the convex hull 404, and this intersection point may be identified as the target point 410. The range of the target point may be set to the location of the intersection between the line and the object feature (e.g., convex hull 404). The velocity of the target point may be the velocity assigned to the object feature as described above, e.g., mean or median velocity of the points in the cluster.

FIG. 5 is a line graph showing an example RV line plotted in RV space according to embodiments of the present disclosure. More specifically, the graph 500 is a graph of the potential beat frequencies fᵤₚ and f_{dn} overlayed over a graph of range and velocity. Each possible combination of fᵤₚ and f_{dn} will generate a unique RV measurement, i.e., a unique pair of range and velocity values. Thus, a graph of fᵤₚ and f_{dn} may be transformed, via a coordinate transformation to a corresponding graph of range and velocity. This graph of range and velocity contains all the valid range and velocity pairs for any value of fᵤₚ and f_{dn} and is referred to herein as RV space. The coordinate transformation may be described as follows:

$$[ \begin{matrix}R \\ V\end{matrix} ] = [ \begin{matrix}α & α \\ β & - β\end{matrix} ] [ \begin{matrix}{f}_{up} \\ {f}_{dn}\end{matrix} ] \qquad Eq . 7$$

The values α and β are described by equations 5 and 6 above and can be derived based on the chirp rate and optical frequency of the transmitted optical signal.

In some cases, the single-frequency detection will be a detection of the up-sweep beat frequency, fᵤₚ. The relationship between R and V for a specific up-sweep beat frequency, fᵤₚ, may be expressed as:

$$V = - \frac{β}{α} R + 2 β {f}_{u p} \qquad Eq . 8$$

In this case, beta, alpha, and the detected beat frequency, fᵤₚ, defines the RV line 502 in RV space. The RV line 502 describes all of the possible combinations of values for range and velocity given the detected beat frequency, fᵤₚ. In frequency space, the RV line 502 is a vertical line at fᵤₚ. Any suitable line notation may be used to characterize the RV line 502 for the purpose of defining, storing, and processing single-frequency detections. For example, a range, R₀, may be computed under the assumption that the velocity is zero, which provides the intersection between the RV line 502 and the range axis (V=0). This is shown in FIG. 5 as point P₀=(R₀, V₀). The slope, m, of the RV line 502 in RV space will be equal to

$$- \frac{β}{α} ,$$

which may be computed based on the chirp rate and optical frequency of the transmitted optical signal. Substituting m for

$$- \frac{β}{α}$$

in equation 8, the range at zero velocity is given by the following equation:

$${R}_{0} = \frac{- 2 β {f}_{u p}}{m} \qquad Eq . 9$$

In some cases, the single-frequency detection will be a detection of the down-sweep beat frequency, f_{dn}. The relationship between R and V for a specific down-sweep beat frequency, f_{dn}, may be expressed as:

$$V = \frac{β}{α} R - 2 β {f}_{dn} \qquad Eq . 10$$

In this case, the beat frequency, f_{dn}, defines the RV line (not shown) in RV space. In frequency space, the RV line would be a horizontal line at f_{dn}. An equivalent R₀m point for known f_{dn} can be derived using the procedure above, where the slope, m, is equal to β/α. Substituting m for β/α in equation 10, the range at zero velocity is given by equation 9 above.

The range at zero velocity (R₀) and the slope, m, provide a numerical representation of the single-frequency detection point that can be stored for further processing. Formatting the data in this way may be referred to as R₀m notation. It will be appreciated that other data points may be used to characterize the RV line and other notation schemes may be used to format the data. For example, the RV line may be characterized by computing a velocity, V₀, under the assumption that the range is zero, which provides the point of intersection between the RV line and the velocity axis (V=0).

Also shown in FIG. 5, is the target range and target velocity (R_{T}, V_{T}) that were generated based on the source of external data as described above. Example techniques for identifying the target range and target velocity are described in relation to FIG. 4. With reference to FIG. 4, the target range and target velocity may be the range and velocity associated with the target point 410 (P_{T}). The target range and target velocity are depicted as a point in RV space referred to herein as the target RV point 504. The target RV point 504 is not to be confused with the points 402 (FIG. 4), which are points in the 3D environment scanned by the LIDAR system.

Given the RV line 502 and the target RV point 504, the estimated RV measurement can be computed by finding a point of the RV line 502 that satisfies some selection criteria. For example, if the selection criteria is to minimize the range difference between the target RV point 504 and the estimated RV measurement, the point on the RV line 502 with the same range at the target RV point 504 may be selected as providing the range and velocity of the estimated RV measurement. This point is shown as the intersection of the RV line 502 and the constant range line 506 extending from the target point 504. If the selection criteria is to minimize the velocity difference between the target RV point 504 and the estimated RV measurement, the point on the RV line 502 with the same velocity at the target RV point 504 may be selected as providing the range and velocity of the estimated RV measurement. This point is shown as the intersection of the RV line 502 and the constant velocity line 508 extending from the target RV point 504.

In some embodiments, the selection criteria may specify selecting the point on the RV line 502 with the shortest distance to the target RV point 504, which is shown by the minimum distance line 510. In some embodiments, the selection criteria may specify selecting the point on the RV line 502 that minimizes the weighted sum of the velocity difference and range difference to the target RV point 504. One or more selection criteria may be used depending on the design details of a specific implementation and/or the preferences of a user. As explained above, the selected point on the RV line 502 identifies estimated range, Rₑₛₜ, and the estimated velocity, Vₑₛₜ, of the estimated RV measurement computed for the single-frequency detection.

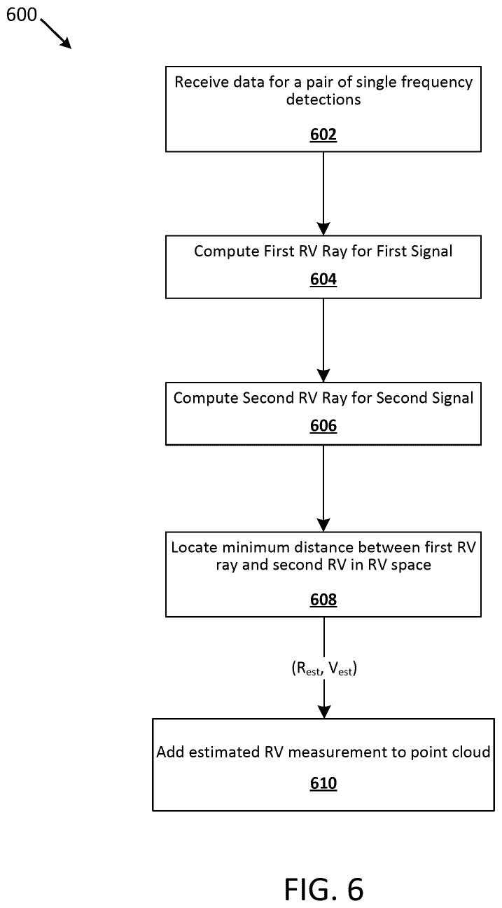

FIG. 6 is a process flow diagram of an example method for generating an estimated range and velocity (RV) measurement based on a pair of single-frequency detections according to embodiments of the present disclosure. The method 600 may be performed by any suitable LIDAR system, including the LIDAR system 100 described above. In addition, this method can be used in addition or in conjunction with traditional dual detection FMCW. For example, the method may be performed by the single-frequency detection module 126 as shown in FIG. 1B. The method may begin at block 602.

At block 602, data is received for a pair of single-frequency detections. In some embodiments, the LIDAR system may be a multi-channel LIDAR that operates at more than one optical frequency. For example, the LIDAR system may generate a first optical signal with a first frequency, f₁, and at least a second optical signal with a second frequency, f₂ In some embodiments, the two signals may be combined into a single laser beam and transmitted simultaneously. The first signal and the second signal are both transmitted with their own up-chirp and down-chirp. Accordingly, each return signal may produce separate up-sweep and down-sweep beat frequencies. The beat frequencies for the first signal are referred to herein as f_{1,up} and f_{1,dn} and the beat frequencies for the second signal are referred to herein as f_{2,up} and f_{2,dn}. In some cases, each signal may result in a single-frequency detection. The method described herein may be used in cases where the opposite beat frequency is detected for the two signals. In other words, f_{1,up} and f_{2,dn} are detected, or f_{1,dn} and f_{2,up} are detected.

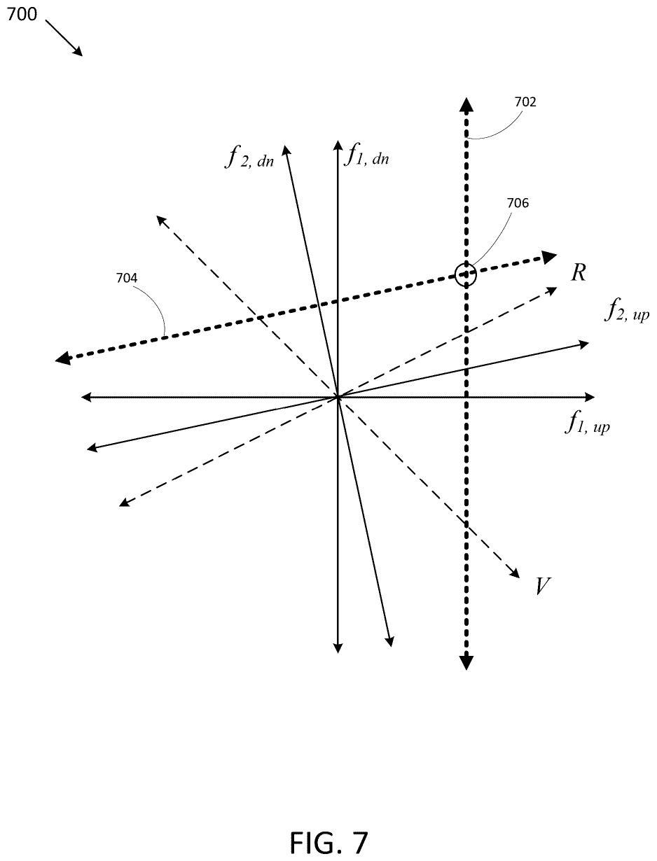

At block 604, a first RV ray is computed for the first signal using the detected beat frequency, f_{1,up} or f_{1,dn}. At block 606, a second RV ray is computed for the second signal using the detected beat frequency, f_{2,up} or f_{2,dn}. The two RV rays may be computed using the techniques described above in relation to FIG. 5. As shown in FIG. 7, the two RV rays may be nearly orthogonal to one another.

At block 608, the point of minimum distance between the first RV ray and second RV ray is located in RV space. The point of minimum distance between the two RV rays in RV space identifies the estimated range, Rₑₛₜ, and the estimated velocity, Vₑₛₜ, to be used for the estimated RV measurement. In cases where the first RV ray and the second RV ray have the same elevation and azimuth, the minimum distance will be the point of intersection.

At block 610, the estimated RV measurement may be added to the point cloud as an estimated point. The estimated point will include the same information as other points of the point cloud including the elevation angle, azimuth angle, and range, or equivalent cartesian coordinates. In some embodiments, the estimated point may be evaluated before being added to the point cloud to determine whether it meets some revival criteria as described above in relation to FIG. 3. In some embodiments, a Boolean value may be added to the estimated point to indicate it was estimated from two single detection points.

It will be appreciated that embodiments of the method 600 may include additional blocks not shown in FIG. 6 and that some of the blocks shown in FIG. 6 may be omitted. Additionally, the processes associated with blocks 602 through 610 may be performed in a different order than what is shown in FIG. 6.

FIG. 7 is a line graph showing an example technique for generating an estimated RF measurement using a pair of single-frequency detections according to embodiments of the present disclosure. Similar to FIG. 3, the graph 700 is a graph of the potential beat frequencies for the first signal (f_{1,dn} versus f_{1,up}) overlayed over a graph of the potential beat frequencies for the second signal (f_{2,dn} versus f_{2,up}), both of which are overlaid over a graph of range and velocity. Both frequency domains map to the same RV space according to the coordinate transformations shown below:

$$[ \begin{matrix}R \\ V\end{matrix} ] = [ \begin{matrix}{α}_{1} & {α}_{1} \\ {β}_{1} & - {β}_{1}\end{matrix} ] [ \begin{matrix}{f}_{1 , up} \\ {f}_{1 , dn}\end{matrix} ] = [ \begin{matrix}{α}_{2} & {α}_{2} \\ {β}_{2} & - {β}_{2}\end{matrix} ] [ \begin{matrix}{f}_{2 , up} \\ {f}_{2 , dn}\end{matrix} ] \qquad Eq . 11$$

The values α and β are described by equations 5 and 6 above and can be derived based on the chirp rates and optical frequencies of the respective signals.

In some cases, the single-frequency detection will be a detection of the up-sweep beat frequency, fᵤₚ. The relationship between R and V for a specific up-sweep beat frequency, fᵤₚ, may be expressed as:

$$V = - \frac{β}{α} R + 2 β {f}_{u p} \qquad Eq . 8$$

In the example shown in FIG. 7, the up-sweep beat frequency has been detected for the first signal, and the down-sweep beat frequency has been detected for the second signal, resulting in a pair of single-frequency detections (f_{1,up} and f_{2,dn}). Since these beat frequencies are for signals with different optical frequencies and/or different chirp rates, equations 5 and 6 cannot be used to compute the range and velocity.

To generate an estimated RV measurement, an RV line may be computed for each signal as described above in relation to FIG. 5. In the example of FIG. 7, the detected beat frequency f_{1,up} defines the RV line 702 in RV space, and the detected beat frequency f_{2,dn} defines the RV line 704 in RV space. The intersection 706 of RV line 702 and RV line 704 identifies the estimated range, Rₑₛₜ, and the estimated velocity, Vₑₛₜ, of the estimated RV measurement computed for the single-frequency detection. For the sake of clarity, the example shown in FIG. 7 is based on both of the single-frequency detections having the same azimuth and elevation angle. In cases where the azimuth and/or elevation are different, the estimated range, Rₑₛₜ, and the estimated velocity, Vₑₛₜ, can be identified by locating a point of minimum distance between the RV line 702 and RV line 704.

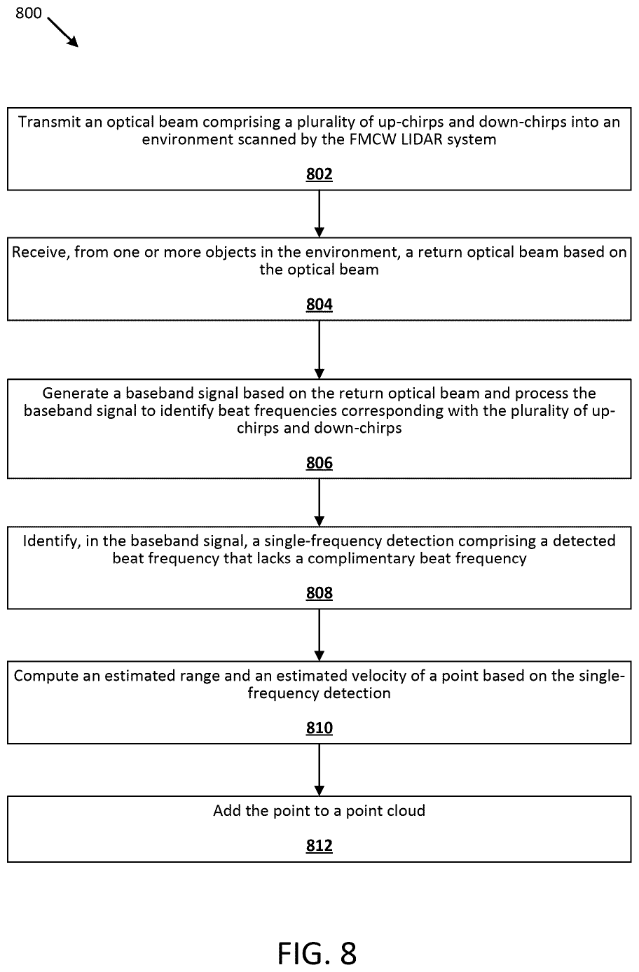

FIG. 8 is a process flow diagram summarizing an example method of generating a point cloud, according to an embodiment of the present disclosure. The method 800 may be performed by any suitable LIDAR system, including the LIDAR system 100 described above. The method may begin at block 802.

At block 802, an optical beam comprising a plurality of up-chirps and down-chirps is transmitted into an environment scanned by the FMCW LIDAR system.

At block 804, a return optical beam is received from one or more objects in the environment, based on the optical beam.

At block 806, a baseband signal is generated based on the return optical beam and processed to identify beat frequencies corresponding with the plurality of up-chirps and down-chirps.

At block 808, a single-frequency detection comprising a detected beat frequency that lacks a complimentary beat frequency is identified in the baseband signal. The single-frequency detection may be a detection of the up-sweep beat frequency but not the down-sweep beat frequency or vice-versa. Additionally, the complimentary beat frequency may be lacking as a result of being disregarded due to reliability issues such as failure to meet some reliability criterion such as a SNR threshold.

At block 810, an estimated range and an estimated velocity of a point is computed based on the single-frequency detection. The estimated range and estimated velocity may be computed in accordance with any of the techniques described herein. For example, computing the estimated range and the estimated velocity of the point may include computing a Range-Velocity (RV) line in RV space that represents combinations of range and velocity that are compatible with the detected beat frequency. A location on the RV line may be identified based on a target range and target velocity provided by an external source of information describing objects in the environment.

At block 812, the point is added to a point cloud. The point may include a variety of information, including the estimated range and velocity.

It will be appreciated that embodiments of the method 800 may include additional blocks not shown in FIG. 8 and that some of the blocks shown in FIG. 8 may be omitted. Additionally, the processes associated with blocks 802 through 812 may be performed in a different order than what is shown in FIG. 8.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operations may be performed, at least in part, concurrently with other operations. Instructions or sub-operations of distinct operations may be performed in an intermittent or alternating manner.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A method of generating a point cloud in a frequency modulated continuous wave (FMCW) light detection and ranging (LIDAR) system, the method comprising:
generating a baseband signal based on an optical beam received from an environment and processing the baseband signal to identify beat frequencies corresponding with a plurality of up-chirps and down-chirps;
identifying, in the baseband signal, a single-frequency detection comprising a detected beat frequency that lacks a complimentary beat frequency;
computing an estimated range and an estimated velocity of a point based on the single-frequency detection; and
adding the point to a point cloud.

2. The method of claim 1, wherein computing the estimated range and the estimated velocity of the point comprises:
computing a Range-Velocity (RV) line in RV space that represents combinations of range and velocity that are compatible with the detected beat frequency; and
identifying a location on the RV line.

3. The method of claim 2, wherein identifying the location on the RV line comprises:
identifying a target based on an external source of information describing objects in the environment, wherein the target describes a range and a velocity of one of the objects in the environment; and
identifying the location on the RV line based on the target.

4. The method of claim 3, wherein identifying the location on the RV line comprises identifying the location with a minimum cartesian distance to the target in RV space.

5. The method of claim 3, wherein identifying the location on the RV line comprises identifying the location that minimizes a weighted sum of a range difference and a velocity difference between the location and the target.

6. The method of claim 3, wherein identifying the target comprises:
computing an RV ray describing a travel direction of the optical beam at a time of the single-frequency detection; and
identifying an intersection of the RV ray with a plane of one of the objects in the environment.

7. The method of claim 3, wherein the external source is a previous frame of the point cloud generated by the FMCW LIDAR system.

8. The method of claim 1, wherein identifying the single-frequency detection comprises rejecting the complimentary beat frequency for failure to meet a reliability criterion.

9. The method of claim 1, wherein the single-frequency detection is a first single-frequency detection and the detected beat frequency is a first detected beat frequency, the method further comprising:
identifying a second single-frequency detection associated with a different optical frequency compared to the first single-frequency detection, wherein the second single-frequency detection comprises a second detected beat frequency;
computing a first RV line that represents combinations of range and velocity that are compatible with the first detected beat frequency; and
computing a second RV line that represents combinations of range and velocity that are compatible with the second detected beat frequency;
wherein computing the estimated range and the estimated velocity of the point comprises locating an intersection of first the RV line and the second RV line.

10. A frequency modulated continuous wave (FMCW) light detection and ranging (LIDAR) system, comprising:
one or more optical receivers to generate a baseband signal from an optical beam received from an environment, wherein the baseband signal comprises beat frequencies; and
a signal processing system coupled to the one or more optical receivers and configured to:
identify, in the baseband signal, a single-frequency detection comprising a detected beat frequency that lacks a complimentary beat frequency;
compute an estimated range and an estimated velocity of a point based on the single-frequency detection; and
add the point to a point cloud.

11. The FMCW LIDAR system of claim 10, wherein to compute the estimated range and the estimated velocity of the point, the signal processing system is to:
compute a Range-Velocity (RV) line in RV space that represents combinations of range and velocity that are compatible with the detected beat frequency; and
identify a location on the RV line.

12. The FMCW LIDAR system of claim 11, wherein to identify the location on the RV line, the signal processing system is to:
identify a target based on an external source of information describing objects in the environment, wherein the target describes a range and a velocity of one of the objects in the environment; and
identify the location on the RV line based on the target.

13. The FMCW LIDAR system of claim 12, wherein to identify the location on the RV line, the signal processing system is to identify the location with a minimum cartesian distance to the target in RV space.

14. The FMCW LIDAR system of claim 12, wherein to identify the location on the RV line, the signal processing system is to identify the location that minimizes a weighted sum of a range difference and a velocity difference between the location and the target.

15. The FMCW LIDAR system of claim 12, wherein to identify the target, the signal processing system is to:
compute an RV ray describing a travel direction of the single-frequency detection in the environment; and
identify an intersection of the RV ray with a plane of one of the objects in the environment.

16. A frequency modulated continuous wave (FMCW) light detection and ranging (LIDAR) system, comprising:
a processing device; and
a memory to store instructions that, when executed by the processing device, cause the LIDAR system to:
receive a baseband signal comprising beat frequencies corresponding with a plurality of up-chirps and a plurality of down-chirps of a returned optical beam received from an environment scanned by the FMCW LIDAR system; and
identify, in the baseband signal, a single-frequency detection comprising a detected beat frequency that lacks a complimentary beat frequency;
compute an estimated range and an estimated velocity of a point based on the single-frequency detection; and
add the point to a point cloud.

17. The FMCW LIDAR system of claim 16, wherein to compute the estimated range and the estimated velocity of the point, the LIDAR system is to:
compute a Range-Velocity (RV) line in RV space that represents combinations of range and velocity that are compatible with the detected beat frequency; and
identify a location on the RV line.

18. The FMCW LIDAR system of claim 17, wherein to identify the location on the RV line, the LIDAR system is to:
identify a target based on an external source of information describing objects in the environment, wherein the target describes a range and a velocity of one of the objects in the environment; and
identify the location on the RV line based on the target.

19. The FMCW LIDAR system of claim 18, wherein to identify the location on the RV line, the signal processing system is to identify the location that minimizes a weighted sum of a range difference and a velocity difference between the location and the target.

20. The FMCW LIDAR system of claim 18, wherein to identify the target, the signal processing system is to:
compute an RV ray describing a travel direction of the single-frequency detection in the environment; and
identify an intersection of the RV ray with a plane of one of the objects in the environment.
